(19) United States
(12) Patent Application Publication
(10) Pub. No.: US 2021/0281010 A1
(43) Pub. Date: Sep. 9, 2021

(54) FIXATION SYSTEM FOR SOCKET CONNECTION FOR SUPPLY VOLTAGE CABLES

(71) Applicant: BLOCKAUDIO s.r.o., Olomouc (CZ)

(72) Inventors: Daniel OUDES, Olomouc (CZ); Jan NEMEC, Tabor (CZ)

(21) Appl. No.: 17/049,587

(22) PCT Filed: May 3, 2019
(86) PCT No.: PCT/CZ2019/000022

§ 371 Date: Oct. 22, 2020

(30) Foreign Application Priority Data
May 7, 2018 (CZ) PUV 2018-34933

(51) Int. Cl. H01R 13/622

(52) U.S. Cl. CPC H01R 13/622

(57) ABSTRACT

The fixation system for socket connection for supply voltage cables containing the socket (1) and the plug (5). The segment (2) is mechanically attached to the socket (1). The external thread (2.1) and the circular frontal part (2.2) are created on the segment (2), wherein the nut (4), ending with the shoulder (4.2) with the inner surface (4.21) is bolted to the external thread (2.1) of the segment (2) with the internal thread (4.1), and wherein the flexible ring (3) is set on the circular frontal part (2.2) of the segment (2). The circular frontal part (2.2) of the segment (2) is flat or bevelled.

### FIELD OF THE INVENTION

This invention relates to the fixation system for socket connection for supply voltage cables, in particular for audio technology; however, use in another area of connection between socket and plug for supply voltage cables is not excluded.

### BACKGROUND OF THE INVENTION

Dimensions and weights of networking cables, including plugs and connectors used specifically in the audio technology industry, have gradually increased multifold over many years of their development; nevertheless, their adequate counterpart (socket) has not practically changed. The socket, which is considerably more stressed by weight load, in principle cannot accommodate increased mechanical loads. In addition, construction of the socket will not significantly change in the future due to standardization and price.

Another factor, increasing stress in the plastic parts of the socket connection, is that the inflexible part of networking connectors is significantly longer compared to the standard design; such established extended foot may increase socket load by nearly 50%. Weight and lower flexibility of copper networking cables, with multifold larger diameter compared to the standard, must be included.

Furthermore, considering unchanged structure of fixation of plugged connector, held prevailingly only by key contacts, dimensions and weights of networking cables may contribute to easy withdrawal of the plug.

Existing, the above-mentioned combination, may also have an impact on safety as even a very small child is able to break, without problems, the existing design of combination of plastic networking connectors and, subsequently, be exposed to the electrical shock hazard.

Connection between the plug and the socket is known from the EP 2511990, where two metal connecting segments with the internal and external thread are used to connect two separate parts. I.e., connection is made by two conductive, conically threaded counterparts. Thus, the sealing ring fulfils only the function of the connection sealing.

### OBJECT OF THE INVENTION

Disadvantages of known plugs and sockets, used for socket connection for supply voltage cables, are overcome by the fixation system for socket connection according to the invention, containing a socket and a plug, wherein a segment is mechanically connected to the socket. An external thread is created on the segment, to which a nut is bolted with its internal thread. The summary of the invention is that said nut is ended with a shoulder with an internal surface. A circular frontal part is created on the segment, wherein a deformable flexible ring, fixing the plug in the socket, is set on the circular part.

The advantage of said invention lies in the elimination of mechanical stress applied to the socket connection. In addition, pulling out or possibility of breaking of the existing connector in the socket is prevented; besides, unintentional pulling out of the cable is prevented, in particular when handling with heavy cables or appliances. Furthermore, the system also eliminates movement and transfer of vibrations to the contacts. Improved stability is another important feature in the area of safety as it deals with line voltage.

The fixation system also effectively prevents penetration of moisture into the contacts thus preventing, or at least dramatically slowing down, their oxidation and, thus, increasing the contact electric resistance.

More stable and improved connection of the mains supply make also a positive contribution to the audio system sound in the area of High-End Audio considering constantly increasing demands on this connection.

### SUMMARY OF FIGURES IN DRAWINGS

Attached drawings illustrate two examples of fixation system construction, showing:

FIG. 1—view on the fixation system installed in the audio technology instrument panel;

FIG. 2—system from FIG. 1, disassembled;

FIG. 3—cross-section A-A of the system from FIG. 1;

FIG. 4—view on the fixation system attached to the socket in the panel;

FIG. 5—system from FIG. 4, disassembled;

FIG. 6—cross-section B-B of the system from FIG. 4.

### DESCRIPTION OF EMBODIMENTS

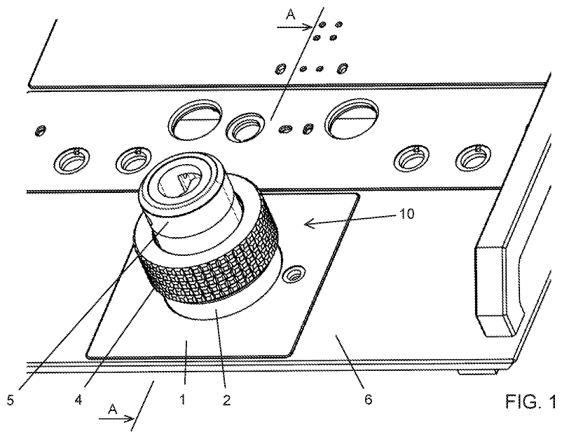

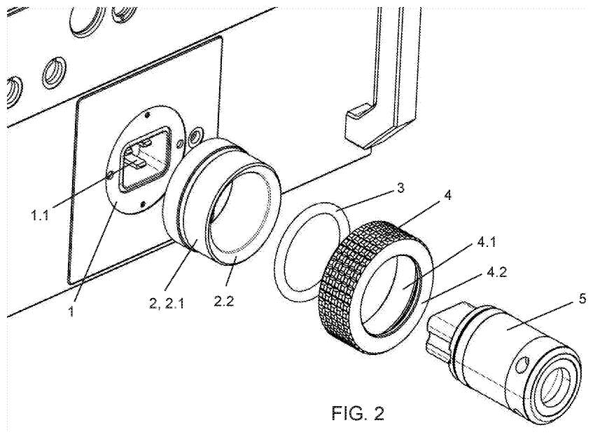

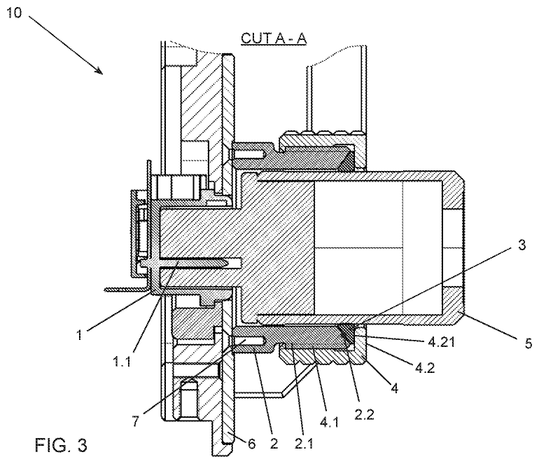

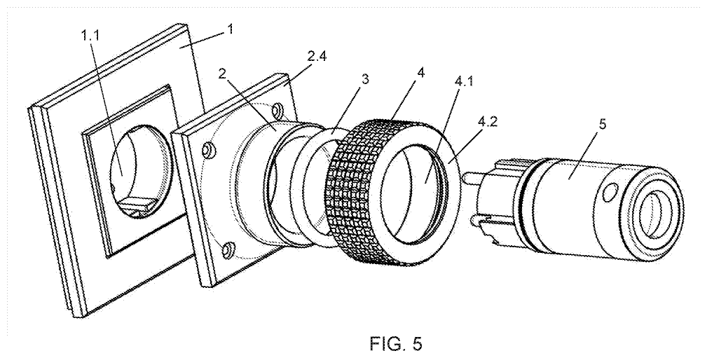

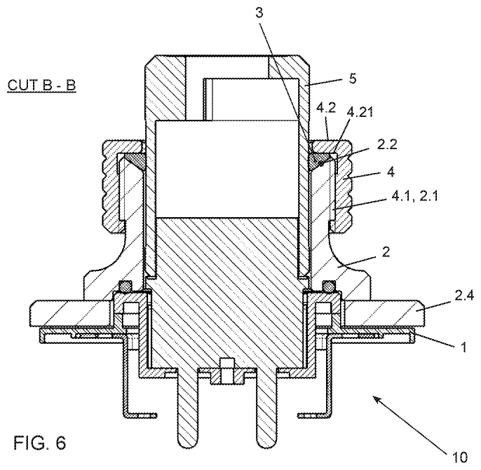

FIGS. 1 to 3 show a fixation system 10 attached to an instrument panel 6 of the audio technology. The fixation system 10 contains a segment 2 with an external thread 2.1 and a circular frontal part 2.2. Said circular frontal part 2.2 may be flat and/or bevelled, as shown in FIGS. 2 and 3 (also in FIGS. 5 and 6 for the example of the fixation system attached to the wall, for instance of an apartment).

The segment 2 is mechanically attached to a socket 1 of the instrument panel 6 of the audio technology, for instance by bolts 7. A nut 4 with an inner thread 4.1 is bolted to the external thread 2.1 of the segment 2. A shoulder 4.2 is created on the nut 4, its inner surface 4.21 establishes pressing area for a deformable flexible ring 3. The deformable flexible ring 3, for example made from rubber, is fit on the circular frontal part 2.2 of the segment 2 and/or may also be inserted into the nut 4 under the inner surface 4.21 of the shoulder 4.2.

To attach a plug 5 to the socket 1, the segment 2 is mechanically fastened to the socket 1 by bolts 7. The nut 2 with the flexible ring 3 is partially bolted to the segment 2. The plug 5 is connected to this assembly of the segment 2, the flexible ring 3 and the nut 4 up to the stop to the connectors 1.1 of the socket 1, afterwards, the nut 4 is fastened, with its inner surface 4.21 of the shoulder 4.2 deforming the flexible ring 3 against the frontal part 2.2 of the segment 2, thus fixing the plug 5 in the socket 1 in the manner that the deformable flexible ring 3 is partially forced in between the external surface of the plug 5 and the internal surface of the segment 2. The final shape of the deformable flexible ring 3 between the internal surface 4.21 of the shoulder 4 and the circular frontal part 2.2 of the segment 2 forms a triangle, wherein the circular frontal part 2.2 of the segment 2 is bevelled (FIG. 3). The final shape of the deformable flexible ring 3 is circular, wherein the circular frontal part 2.2 of the segment 2 is flat.

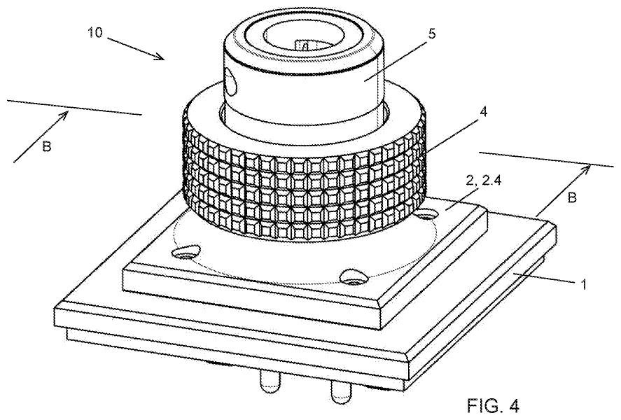

FIGS. 4 to 6 show the fixation system 10 attached to the socket 1 in the wall 6 (for instance, a regular brick wall). The fixation system 10 contains identically arranged construction elements as described in the example shown in FIGS. 1 to 3; therefore, they will not be described again. Only the segment 2 is mounted with a square basic surface 2.4, mechanically fastened to the socket 1 with bolts, attached to the wall 6. Furthermore, the process of attachment of the plug into the socket is identical to the process described in the example of embodiment, shown in FIGS. 1 to 3.

The fixation system is compatible with majority of networking connectors, in particular High End Audio technology; however, use in another area of connection between socket and plug is not excluded for supply voltage cables.

1. The fixation system for socket connection for supply voltage cable containing the socket (1) and the plug (5), the segment (2) is mechanically connected to the socket (1), the external thread (2.1) is created on the segment (2), to which the nut (4) is bolted with its internal thread (4.1),
characterized in that
the nut (4) is ended with the shoulder (4.2) with the internal surface (4.21), the circular frontal part (2.2) is created on the segment (2), wherein the deformable flexible ring (3) is set on the circular frontal part (2.2), through which the plug (5) is fixed in the socket (1).

2. The fixation system according to claim 1, characterized in that the circular frontal part (2.2) of the segment (2) is flat or bevelled.
